(19) United States
(12) Patent Application Publication
(10) Pub. No.: US 2020/0274132 A1
(43) Pub. Date: Aug. 27, 2020

(54) ELECTRICAL CELL CONNECTION ARRANGEMENTS AND METHOD THEREOF

(71) Applicant: TIVENI MERGECO, INC., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/798,746

(22) Filed: Feb. 24, 2020

Related U.S. Application Data
(60) Provisional application No. 62/809,349, filed on Feb. 22, 2019.

(51) Int. Cl. H01M 2/20; H01M 2/30; H01R 25/16

(52) U.S. Cl. CPC H01M 2/206; H01M 2220/20; H01R 25/161; H01M 2/30

(57) ABSTRACT

In an embodiment, a multi-cell hold-down mechanism is clamped over multiple contact tabs aligned with respective cell terminals (e.g., positive and/or negative cell terminal(s). While clamped, the contact tabs are securely welded to respective cell terminals through respective gaps in the multi-cell hold-down mechanism. In another embodiment, a multi-cell hold-down mechanism is clamped over an electrically conductive part that is coupled to multiple cell rims which are configured as negative cell terminals. A respective negative contact tab is welded to the electrically conductive part through a gap in the multi-cell hold-down mechanism. In another embodiment, three (or more) battery cell terminals (e.g., positive or negative terminals) are coupled to an electrically conductive bar that is welded to a contact tab of a busbar.

### CROSS-REFERENCE TO RELATED APPLICATIONS

The present application for patent claims the benefit of U.S. Provisional Application No. 62/809,349 with attorney docket no. TIV-180009P1, entitled “ELECTRICAL CELL CONNECTION ARRANGEMENTS”, filed Feb. 22, 2019, which is assigned to the assignee hereof and hereby expressly incorporated by reference herein in its entirety.

### BACKGROUND

### 1. Field of the Disclosure

Embodiments relate to electrical cell connection arrangements, particularly for battery cells arranged in a battery module.

### 2. Description of the Related Art

Energy storage systems may rely upon battery cells for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

An embodiment is directed to an electrical cell connection arrangement for a battery module, comprising a first battery cell comprising a first terminal, a second battery cell comprising a second terminal, at least one busbar comprising a first contact tab aligned with the first terminal and a second contact tab aligned with the second terminal, a multi-cell hold-down mechanism that comprises a first part clamped over the first contact tab and a second part clamped over the second contact tab, wherein the first contact tab is welded to the first terminal through a first gap in the first part of the multi-cell hold-down mechanism, and wherein the second contact tab is welded to the second terminal through a second gap in the second part of the multi-cell hold-down mechanism.

Another embodiment is directed to a method of assembling a battery module, comprising aligning a first contact tab of at least one busbar with a first terminal of a first battery cell, aligning a second contact tab of the at least one busbar with a second terminal of a second battery cell, clamping a multi-cell hold-down mechanism onto the first and second contact tabs such that the first and second contact tabs are secured to the first and second terminals, welding, during the clamping, the first contact tab to the first terminal through a first gap in a first part of the multi-cell hold-down mechanism, and welding, during the clamping, the second contact tab to the second terminal through a second gap in a second part of the multi-cell hold-down mechanism.

Another embodiment is directed to an electrical cell connection arrangement for a battery module, comprising a first battery cell comprising a first positive terminal and a first cell rim arranged as a first negative terminal, a second battery cell comprising a second positive terminal and a second cell rim arranged as a second negative terminal, an electrically conductive part coupled to the first and second cell rims, a busbar comprising a negative contact tab, and a multi-cell hold-down mechanism that is clamped over the electrically conductive part, wherein the negative contact tab is welded to a welding interface of the electrically conductive part that is exposed through a gap in the multi-cell hold-down mechanism.

Another embodiment is directed to an electrical cell connection arrangement for a battery module, comprising a first battery cell comprising a first terminal, a second battery cell comprising a second terminal, a third battery cell comprising a third terminal, an electrically conductive part coupled to the first, second and third terminals, and a busbar comprising a contact tab that is welded to a welding interface of the electrically conductive part.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of a battery module that shows P groups 1 . . . N connected in series in accordance with an embodiment of the disclosure.

FIG. 3 illustrates a battery module during assembly after battery cells are inserted therein.

FIGS. 4A-4C illustrate the general arrangement of contact plate(s) with respect to battery cells of a battery module.

FIG. 5 illustrates an example of the layers of a conventional multi-layer contact plate 500.

FIG. 6 illustrates a cell connection configuration for a battery module in accordance with an aspect of the disclosure.

FIGS. 7A-7C illustrates various finger types of busbars in the cell connection configuration of FIG. 6 in accordance with an embodiment of the disclosure.

FIG. 7D illustrates an example battery module configuration whereby sixteen (16) different busbar (or finger) types are used, some of which include a single positive contact tab, some of which include two positive contact tabs and some of which include three positive contact tabs.

FIG. 8 illustrates a multi-cell hold-down mechanism in accordance with an embodiment of the disclosure.

FIG. 9 illustrates a multi-cell hold-down mechanism in accordance with another embodiment of the disclosure.

FIG. 10A illustrates a side-perspective depicting a negative contact tab being welded to a corresponding negative cell terminal in accordance with an embodiment of the disclosure.

FIG. 10B illustrates a side-perspective depicting a negative contact tab being welded to a corresponding negative cell terminal in accordance with another embodiment of the disclosure.

FIG. 11A illustrates hold-down mechanisms in accordance with other embodiments of the disclosure.

FIG. 11B illustrates a three-cell hold-down mechanism in accordance with an embodiment of the disclosure.

FIG. 11C illustrates a battery module assembly process in accordance with an embodiment of the disclosure.

FIG. 12A illustrates a cell connection configuration for a battery module accordance with another embodiment of the disclosure.

FIG. 12B illustrates busbars that are deployed in accordance with the cell connection configuration of FIG. 12A.

FIG. 12C illustrates a side-perspective of the cell connection configuration of FIG. 12B in accordance with an embodiment of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

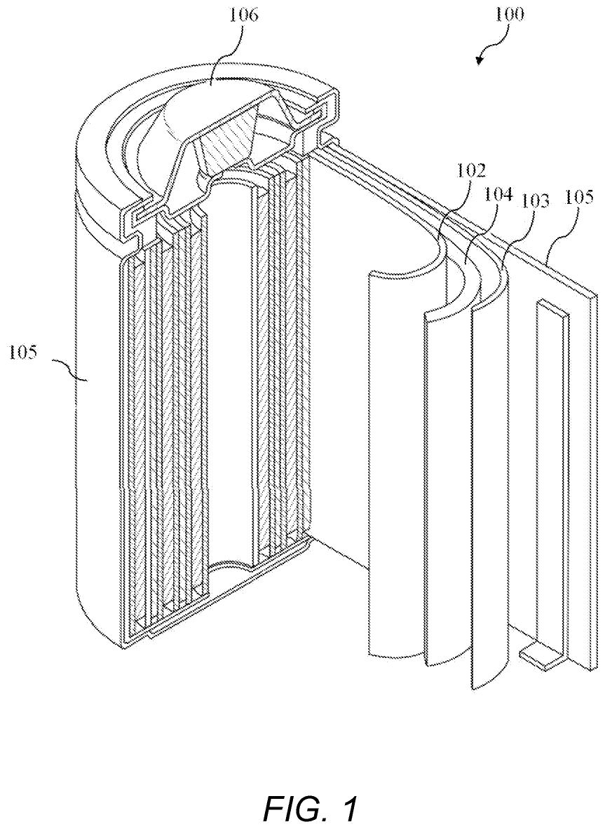

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

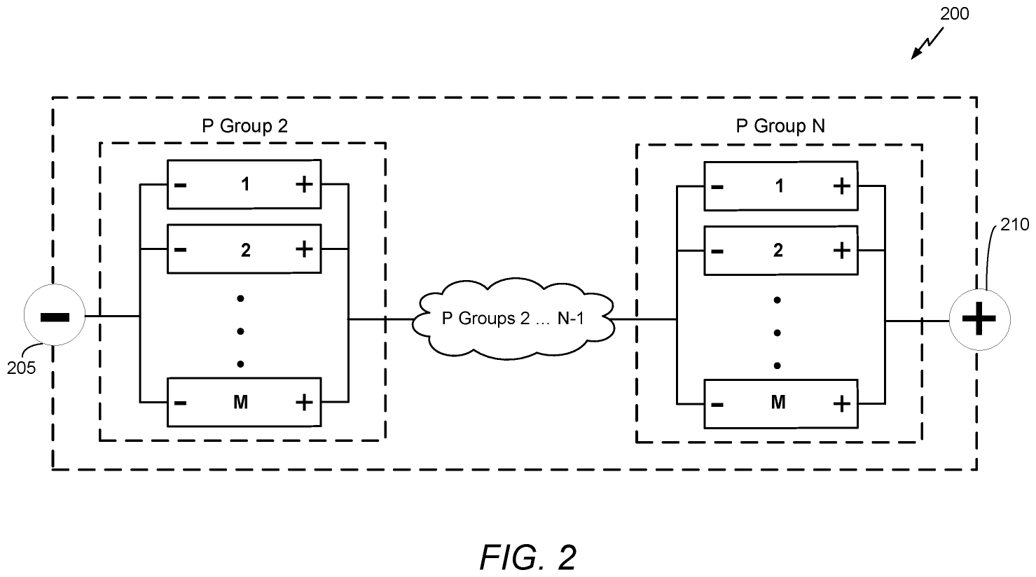

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

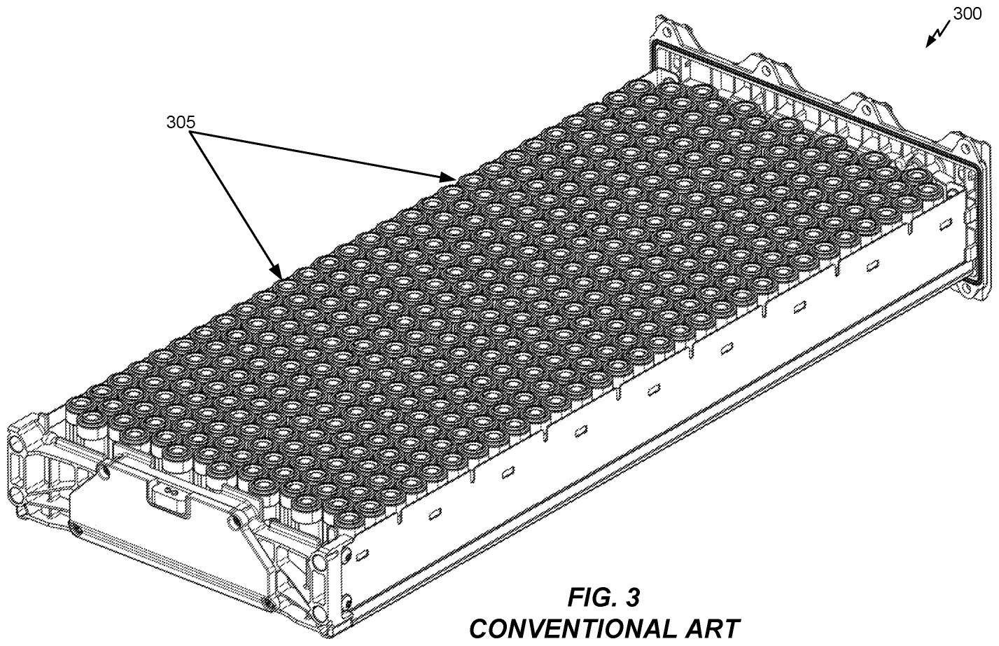

FIG. 3 illustrates a battery module 300 during assembly after battery cells 305 are inserted therein. In some designs, both the positive terminal (cathode) and negative terminal (anode) of the battery cells in the battery module 300 may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

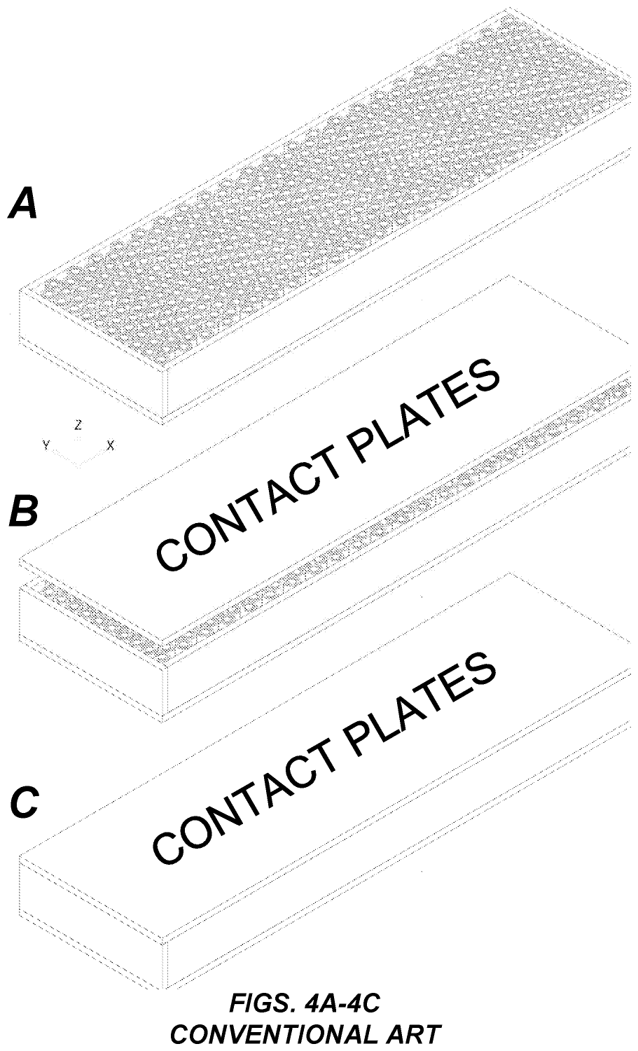

FIGS. 4A-4C illustrate the general arrangement of contact plate(s) with respect to battery cells of a battery module. As shown in FIGS. 4A-4C, the contact plates may be arranged on top of the battery cells in close proximity to their respective positive and negative terminals in some designs.

There are a variety of ways in which the above-noted contact plates may be configured. For example, the contact plates can be configured as solid blocks of aluminum or copper, whereby bonding connectors are spot-welded between the contact plates and the positive and negative terminals of the battery cells. Alternatively, a multi-layer contact plate that includes an integrated cell terminal connection layer may be used.

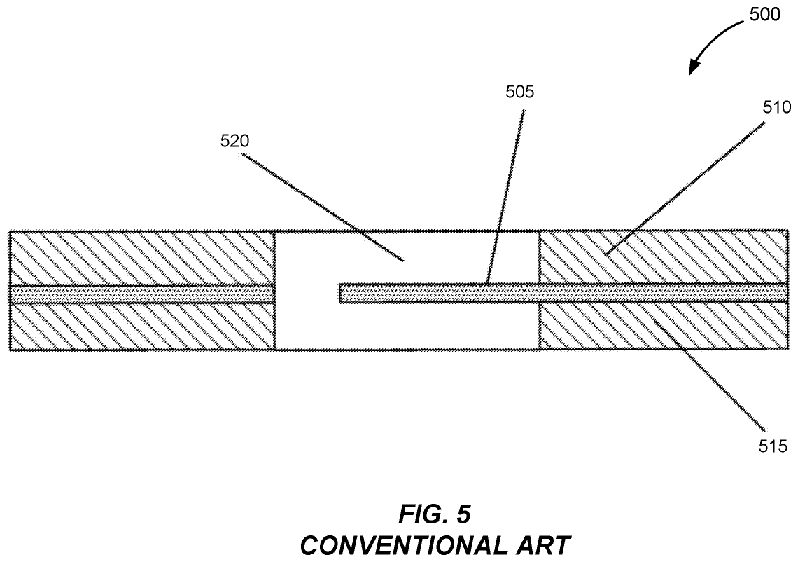

FIG. 5 illustrates an example of the layers of a conventional multi-layer contact plate 500. In FIG. 5, the multi-layer contact plate 500 includes a flexible cell terminal connection layer 505 that is sandwiched between a top conductive plate 510 and a bottom conductive plate 515. In an example, the top and bottom conductive plates 510 and 515 may be configured as solid Cu or Al plates (e.g., or an alloy of Cu or Al), while the flexible cell terminal connection layer 505 is configured as foil (e.g., steel or Hilumin foil). A number of holes, such as hole 520, are punched into the top and bottom conductive plates 510 and 515, while some part of the flexible cell terminal connection layer 505 extends out into the hole 520. During battery module assembly, the part of the flexible cell terminal connection layer 505 that extends into the hole 520 can then be pressed downward so as to contact a positive or negative terminal of one or more battery cells arranged underneath the hole 520, and then welded to obtain a mechanically stable plate-to-terminal electrical connection.

Referring to FIG. 5, the layers of the multi-layer contact plate 500 may be joined via soldering or brazing (e.g., based on soldering or brazing paste being arranged between the respective layers before heat is applied), which results in soldering or brazing “joints” between the respective layers. These joints provide both (i) an inter-layer mechanical connection for the multi-layer contact plate 500, and (ii) an inter-layer electrical connection for the multi-layer contact plate 500.

Referring to FIG. 5, one of the advantages of configuring the flexible cell terminal connection layer 505 with a different material (e.g., steel or Hilumin) than the surrounding top and bottom conductive plates 510 and 515 (e.g., Cu, Al, or an alloy thereof) is so that the cell terminal connections can be welded via like metals. For example, it is common for cell terminals to be made from steel or Hilumin. However, steel is not a particularly good conductor. Hence, the top and bottom conductive plates 510 and 515 are made from a more conductive material (e.g., Cu, Al, or an alloy thereof) than steel, while steel is used in the flexible cell terminal connection layer 505 to avoid disparate metals being welded together for the cell terminal connection.

In an alternative embodiment to the contact plate configuration depicted in FIG. 5, instead of two solid plates sandwiching a foil terminal connection layer, a contact plate (e.g., Cu, Al, or an alloy thereof, although it is possible for the contact plate to be multi-layer) can be coated with a thin layer of a different metal (e.g., steel or Hilumin) that is suitable to be welded to one or more battery cell terminals. The coated contact plate can be locally punched or etched to define specific sections that (i) can be moved flexibly, or (ii) can be configured as a fuse, or (iii) can be made suitable for welding to the battery cell terminal(s).

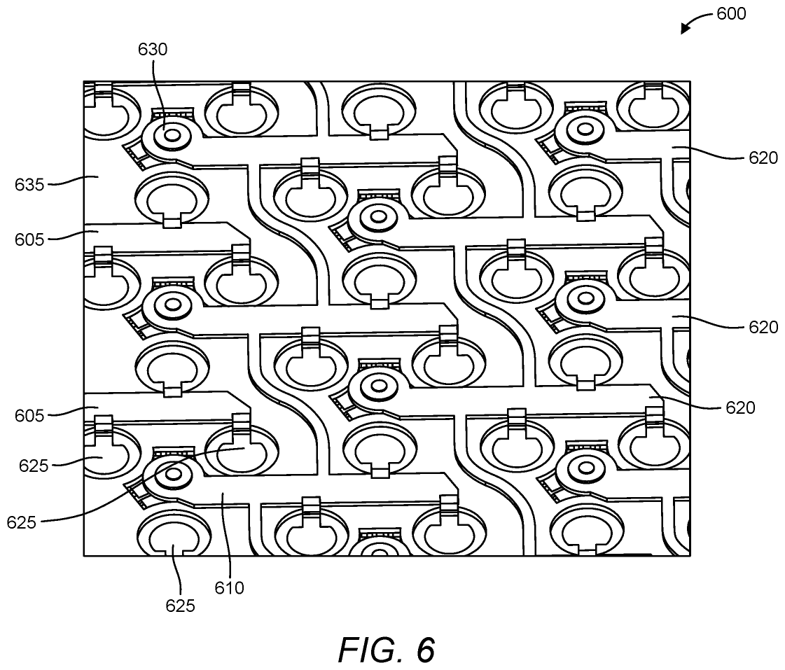

FIG. 6 illustrates a cell connection configuration 600 for a battery module in accordance with an aspect of the disclosure. The cell connection configuration 600 may be arranged over battery cells (not shown in FIG. 6) similar to the contact plates described above with respect to FIGS. 4A-4C. In FIG. 6, the cell connection configuration 600 comprises a plurality of busbars 605, 610 and 620, each of which is arranged with (or coupled to) a plurality of positive contact tabs 625 and negative contact tab assembly (e.g., including a washer, pin and Hilumin sheet metal tabs) 630. In the specific ‘three-cell’ design of FIG. 6, each positive contact tab 625 is configured to form a direct electrical connection to a corresponding positive terminal of one particular battery cell (e.g., the inner cell ‘head’ of the top-side of the battery cell), and each negative contact tab 630 is configured to connect to corresponding negative terminals of three battery cells (e.g., making contact with part of the negative cell ‘rim’ of the top-side of the battery cell). While not shown in FIG. 6, not all cells need be grouped in accordance with the three-cell design (e.g., the cells at either end of the busbars may be grouped differently due to spacing limitations, etc.).

Referring to FIG. 6, each of the busbars 605-620 is arranged as a series of linked ‘fingers’, with all contact tabs being arranged on the fingers. An insulation layer 635 is also included to help electrically isolate the busbars 605-620 from each other as well as the cell terminals located below. The busbars 605-620 may collectively function to chain particular P-Groups of battery cells together in series, as described above. In some designs, the various negative contact tabs may correspond to a non-sandwiched protruding part of a ‘sandwiched’ terminal connection layer (e.g., steel or Hilumin) integrated into the respective busbars. In other words, in this example, the negative contact tabs (or negative contact tab assemblies) are not welded or affixed to the busbars 605-620, but rather protrude out from a hole defined in the top/bottom sandwiching plates (e.g., formed from Cu or Al) of the busbar structure. However, in other designs, the various negative contact tabs may instead be welded or otherwise affixed to the busbars (as opposed to being integrated into the busbars as a protruding non-sandwiched part of a sandwiched layer).

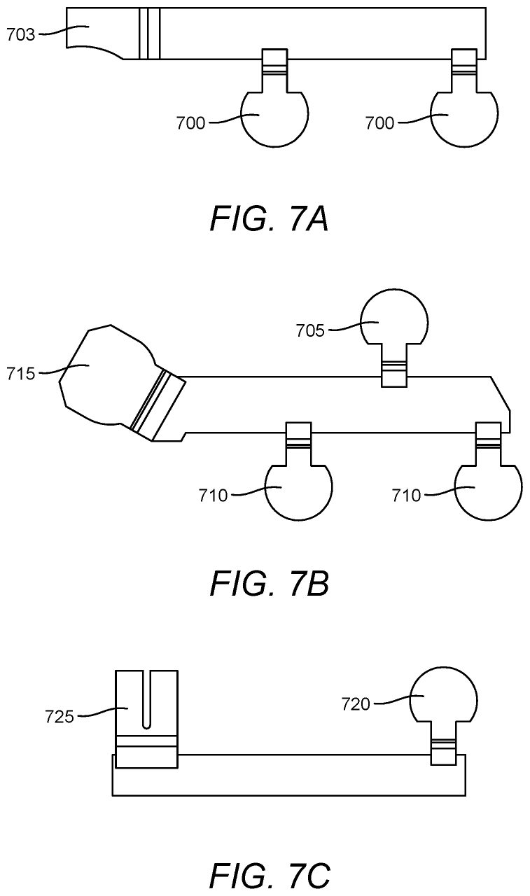

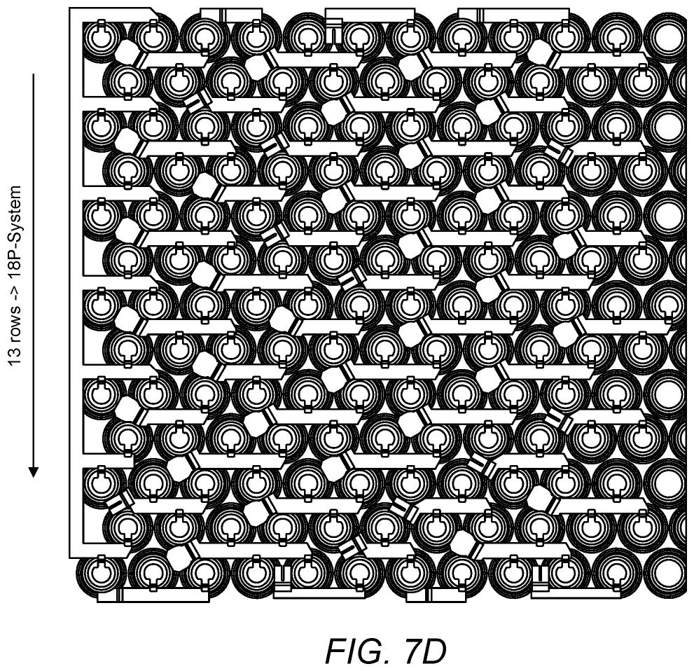

FIGS. 7A-7C illustrates the various finger types of the busbars 605-620 in the cell connection configuration 600 of FIG. 6 in accordance with an embodiment of the disclosure. As will be appreciated, the number of contact tabs may vary between finger types. The finger type illustrated in FIG. 7A comprises two positive contact tabs 700 and single-cell negative contact tab 703, the finger type illustrated in FIG. 7B comprises three positive contact tabs 705-7100 and a single multi-cell negative contact tab 715 which is configured to connect to negative terminals of three different battery cells, and the finger type illustrated in FIG. 7C comprises a single positive contact tab 720 and a single multi-cell negative contact tab 725 which is configured to connect to negative terminals of two different battery cells. In an example, the single fingers can be electrically connected to each other, to maintain substantially the same voltage level in a particular P-group.

It will further be appreciated that additional finger types may also be used depending on the specific battery module configuration being used. FIG. 7D illustrates an example battery module configuration whereby sixteen (16) different busbar (or finger) types are used, some of which include a single positive contact tab, some of which include two positive contact tabs and some of which include three positive contact tabs. Moreover, the negative contact tab (or negative contact tab assembly) of each busbar type in FIG. 7D can be configured for connecting to a single negative cell terminal, two negative cell terminals or three negative cell terminals. Hence, the various finger types described herein are non-limiting examples, and there are numerous finger type configurations that may be used.

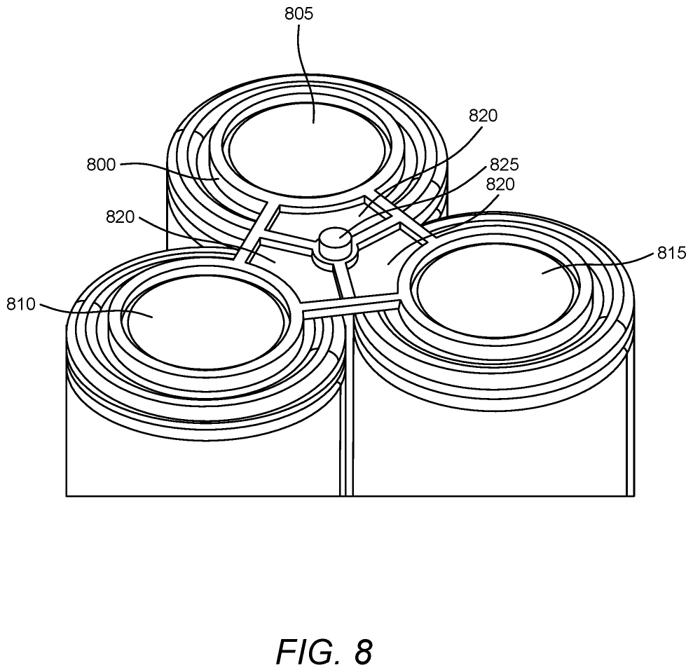

FIG. 8 illustrates a multi-cell hold-down mechanism 800 in accordance with an embodiment of the disclosure. More specifically, the multi-cell hold-down mechanism 800 is an example of a three-cell hold-down mechanism that facilitates welding of corresponding contact tabs to the positive and negative cell terminals of three respective battery cells. Even more specifically, in the example of FIG. 8, the multi-cell hold-down mechanism 800 helps to hold-down an electrically conductive part (e.g., comprising a flat section or sheet metal part and an electrically conductive pin) by applying clamping force thereto so as to secure the sheet metal part while a negative contact tab of a busbar is being welded to the pin. In FIG. 8, it is assumed that the inner cell ‘head’ of each cell corresponds to the positive terminal, while the outer cell ‘rim’ of each cell corresponds to the negative terminal, such that both positive and negative terminals are arranged on the same end of the cylindrical battery cell.

Referring to FIG. 8, the multi-cell hold-down mechanism 800 is arranged with four distinct sections, with three outer sections encircling the positive cell terminals of the three cells, and an inner section arranged over the negative cell terminals of the three cells. In an example, the inner and outer sections of the multi-cell hold-down mechanism 800 may be formed from an electrically insulative material such as plastic. Moreover, the three outer sections each comprises a gap denoted as 805, 810 and 815, respectively, while the inner hold-down section comprises three gaps that expose a respective sheet metal part 820. In an example, the gaps 805-815 may be used to facilitate welding of positive contact tabs (not shown) through the gaps directly to the positive cell terminals. The gaps in the sheet metal part 820 may define welding chambers (or welding areas) for the sheet metal part 820 (e.g., the sheet metal part 820 is welded three times—once per chamber, which results in the sheet metal part 820 being welded to the respective negative cell rims). In an example, the welding in the welding chambers may be performed during module assembly or alternatively as a pre-assembly procedure. The three outer sections, each of which may encircle a corresponding positive cell terminal, may provide short circuit protection and alignment on the cell stack (e.g., to keep the positive contact tab in proper position during welding). For example, the outer sections encircling the positive cell terminals of the three cells may be arranged so as to be taller than either the cell head or cell rim and may function as dividers (or walls) between the respective positive and negative cell terminals of each cell (e.g., to increase an electrical creeping distance, to block sparks from welding, etc.).

Also shown in FIG. 8 is an electrically conductive pin 825 (e.g., made from aluminum or copper in an example), which may be welded to the sheet metal part 820, may be used to improve an electrical connection to a corresponding negative contact tab. During battery module assembly, the pin 825 may be welded to the negative contact tab, as will be described below in more detail. The sheet metal part and the electrically conductive pin 825 may collectively be referred to herein as an electrically conductive part.

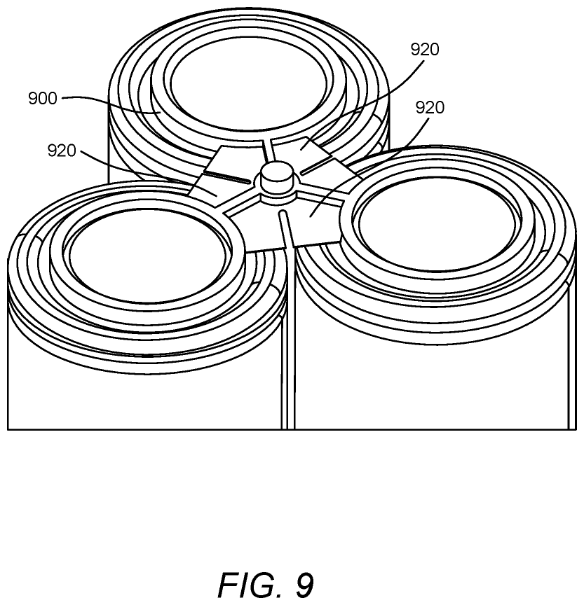

FIG. 9 illustrates a multi-cell hold-down mechanism 900 in accordance with another embodiment of the disclosure. The multi-cell hold-down mechanism 900 is configured similarly to the multi-cell hold-down mechanism 800 of FIG. 8 except for the inner section, whereby a sheet metal part 920 (or flat section) is exposed to permit welding to the respective cell rims in respective welding areas without welding chambers as in FIG. 8. In FIG. 9, the sheet metal part 920 includes cutouts (or slits) to permit clamping by some other mechanism.

In FIGS. 8-9, the multi-cell hold-down mechanisms 800 and 900 may be pre-assembled before assembly of the battery module, such that the three battery cells (and their associated multi-cell hold-down mechanism) are placed into the battery module as a single pre-assembled component. In some designs, the welding of the sheet metal part to the respective cell rims through gaps in the multi-cell hold-down mechanisms 800 and 900 may likewise be implemented before assembly of the battery module.

In FIGS. 8-9, the welding interface between the electrically conductive part (e.g., flat section and pin) is the electrically conductive pin 825. In other designs, the electrically conductive pin 825 can be replaced with a part having a different shape (e.g., other than a pin shape, such as a cone, a curved shape, etc.). In some designs, the welding interface (pin-shaped or otherwise) may generally protrude up from the flat section and may be wrapped by part of the multi-cell hold-down mechanisms 800 and 900 (e.g., to secure the welding interface in place during welding).

While FIGS. 8-9 depict examples of three-cell multi-cell hold-down mechanisms 800 and 900, in other designs, the multi-cell hold-down mechanisms 800 and 900 can be modified to accommodate a different number of cells (e.g., a two-cell multi-cell hold-down mechanism, a four-cell multi-cell hold-down mechanism, etc.).

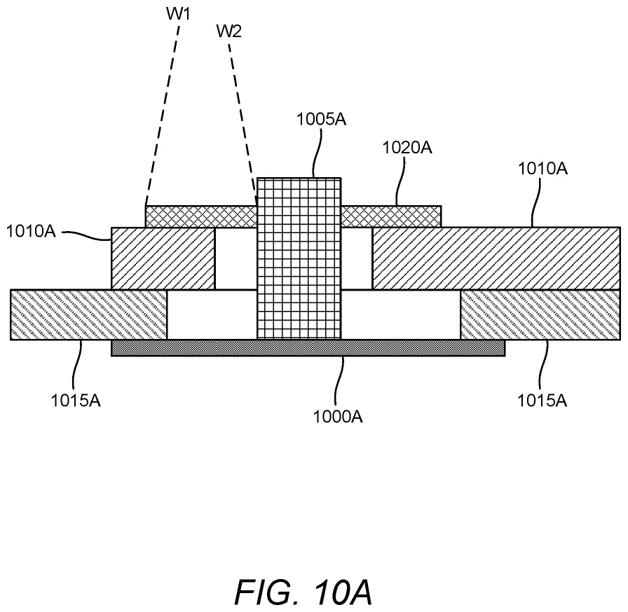

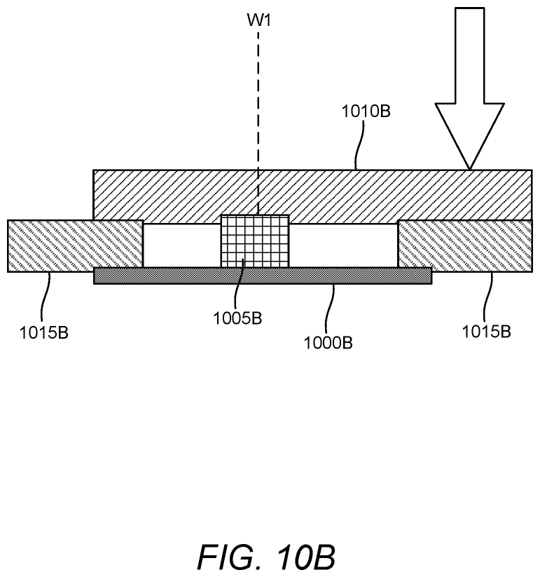

FIG. 10A illustrates a side-perspective depicting a negative contact tab being welded to a corresponding negative cell terminal in accordance with an embodiment of the disclosure. In FIG. 10A, a sheet metal part 1000A (e.g., the sheet metal part 820 of FIG. 8, or the sheet metal part 920 of FIG. 9) is welded to a pin 1005A (e.g., an Al or Cu pin, such as pin 825 of FIGS. 8-9). While not shown in FIG. 10A, three battery cells may be arranged beneath the sheet metal part 1000A, and the sheet metal part 1000A may be welded to negative cell rims of these three battery cells. A negative contact tab 1010A of a busbar is arranged on top of the sheet metal part 1000A, with an intervening insulation layer 1015A for electrical isolation. In the embodiment of FIG. 10A, a hole is defined in the negative contact tab 1010A, with the pin 1005A protruding into the hole. A washer 1020A is integrated into the negative contact tab 1010A and is wrapped around the pin 1005A for tolerance compensation. In the example depicted in FIG. 10A, the negative contact tab 1010A is welded to the pin 1005A via a welding seam (W1, W2) across the washer 1020A at the inner and outer parts of the washer 1020A. In an example, while not shown explicitly in the side-perspective of FIG. 10A, a number of welding seams may be applied (e.g., 3 welding seams with one welding seam per welding chamber or cell connection, 6 welding seams with two welding seams per welding chamber or cell connection, etc.).

FIG. 10B illustrates a side-perspective depicting a negative contact tab being welded to a corresponding negative cell terminal in accordance with another embodiment of the disclosure. In FIG. 10B, a sheet metal part 1000B (e.g., the sheet metal part 820 of FIG. 8, or the sheet metal part 920 of FIG. 9) is welded to a pin 1005B (e.g., an Al or Cu pin, such as pin 825 of FIGS. 8-9). While not shown in FIG. 10B, three battery cells may be arranged beneath the sheet metal part 1000B, and the sheet metal part 1000B may be welded to negative cell rims of these three battery cells. A negative contact tab 1010B of a busbar is arranged on top of the sheet metal part 1000B, with an intervening insulation layer 1015B for electrical isolation. In the embodiment of FIG. 10B, a hole and washer arranged as in FIG. 10A is not used. Instead, the negative contact tab 1010B is pressed down onto the pin 1005B and then welded onto pin 1005B via a single weld (W1). A nominal overlap (e.g., 0, 3-0, 8 mm) is defined between the pin 1005B and the negative contact tab 1010B at the welding site. In some designs, the nominal overlap may be minimized to improve the connection between the negative contact tab 1010B and the pin 1005B at the welding site.

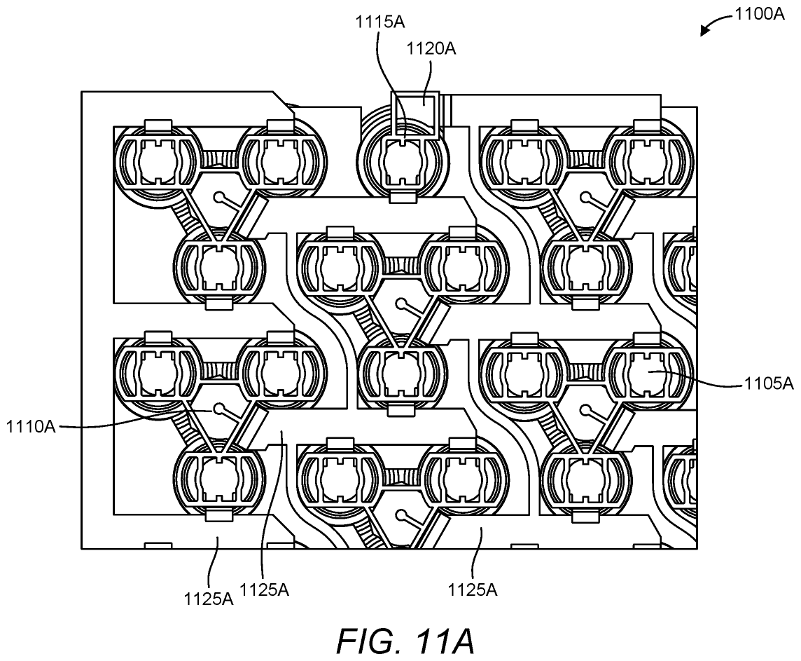

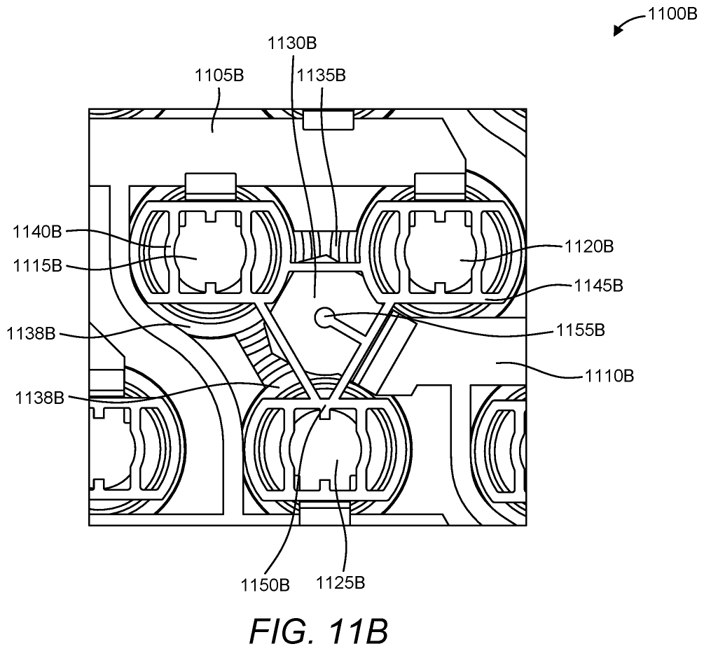

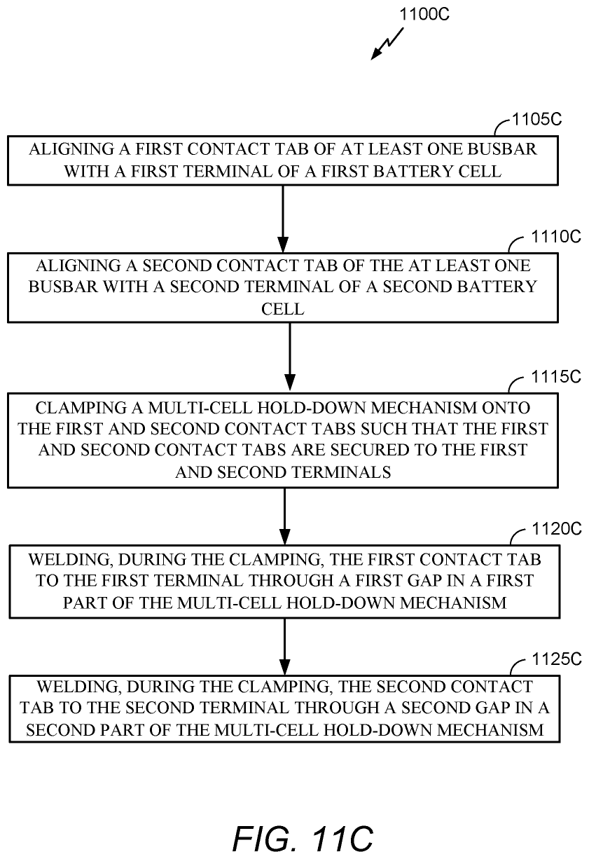

FIG. 11A illustrates hold-down mechanisms 1100A in accordance with other embodiments of the disclosure. As shown in FIG. 11A, three-cell hold-down mechanisms 1105A-1110A (described in more detail below with respect to FIG. 11B) may be deployed along with other hold-down mechanisms (e.g., one-cell hold-down mechanisms 1115A-1120A, etc.) depending on the cell configuration of the battery module. In FIG. 11A, 1115A depicts a positive one-cell hold-down mechanism, whereas 1120A depicts a negative one-cell hold-down mechanism.

FIG. 11B illustrates a three-cell hold-down mechanism 1100B in accordance with an embodiment of the disclosure. Referring to FIG. 11B, busbars 1105B and 1110B are arranged over a group of three battery cells. Busbar 1105B includes positive contact tabs 1115B, 1120B and 1125B arranged over the group of three battery cells, and busbar 1110B includes negative contact tab 1130B. The negative contact tab 1130B is arranged over an electrically conductive part 1135B (e.g., a sheet metal part, which may correspond to an exposed part of the sheet metal part 920 of FIG. 9) and is coupled to negative cell rims 1138B of the same group of three battery cells.

A multi-cell hold-down mechanism is further depicted, whereby the multi-cell hold-down mechanism includes a first part 1140B clamped over the positive contact tab 1115B, a second part 1145B clamped over the positive contact tab 1120B, a third part 1150B clamped over the positive contact tab 1125B, and a fourth part 1155B clamped over the negative contact tab 1130B.

As shown in FIG. 11B, each of parts 1140B-1155B of the multi-cell hold-down mechanism includes a respective gap through which a welding operation can be performed to weld the associated contact tab to one or more cell terminals (not visible in FIG. 11B) arranged underneath the contact tab. The clamping pressure applied by the multi-cell hold-down mechanism may help to secure the respective contact tabs against the respective cell terminals during the welding operation. In some designs, the multi-cell hold-down mechanism can be removed (at least in part) after the welding, whereas in other designs the multi-cell hold-down mechanism can remain part of the battery module after the welding.

While FIG. 11B is described with respect to a three-cell design for the multi-cell hold-down mechanism, multi-cell hold-down mechanisms in accordance with other embodiments can include any number of cell configurations (e.g., single-cell, two-cell, four-cell, etc.). In an example, the multi-cell hold-down mechanism depicted in FIG. 11B may comprise an electrically insulative material, such as plastic.

FIG. 11C illustrates a battery module assembly process 1100C in accordance with an embodiment of the disclosure. In an example, the battery module assembly process 1100C may be used to produce the module configurations depicted in FIGS. 11A-11B.

Referring to FIG. 11C, at 1105C, a first contact tab of at least one busbar is aligned with a first terminal of a first battery cell. At 1110C, a second contact tab of the at least one busbar is aligned with a second terminal of a second battery cell. At 1115C, a multi-cell hold-down mechanism (e.g., made from an electrically insulative material such as plastic) is clamped onto the first and second contact tabs such that the first and second contact tabs are secured to the first and second terminals. At 1120C, during the clamping of 1115C, the first contact tab is welded (e.g., laser welded, etc.) to the first terminal through a first gap in a first part of the multi-cell hold-down mechanism. At 1125C, during the clamping of 1115C, the second contact tab is welded (e.g., laser welded, etc.) to the second terminal through a second gap in a second part of the multi-cell hold-down mechanism.

As will be appreciated from the description of FIGS. 11A-11B, the first and second terminals may be positive terminals (e.g., arranged under the positive contact tabs 1115-1125B, etc.), or the first terminal may be a positive terminal (e.g., arranged under one of positive contact tabs 1115-1125B, etc.) and the second terminal may be a negative terminal (e.g., arranged under the negative contact tab 1130B, etc.). In some designs, one of the first and second contact tabs may be a multi-terminal contact tab that is coupled to negative terminals of the first and second battery cells (e.g., negative contact tab 1130B, which is indirectly coupled to the cells of the three battery cells via welding to the electrically conductive part 1135B. In some designs, the multi-cell hold-down mechanism comprises a plurality of parts aligned with a respective plurality of positive terminals of a respective plurality of battery cells, and the multi-cell hold-down mechanism that comprises a single part (e.g., 1155B) aligned with a respective plurality of negative terminals of the respective plurality of battery cells

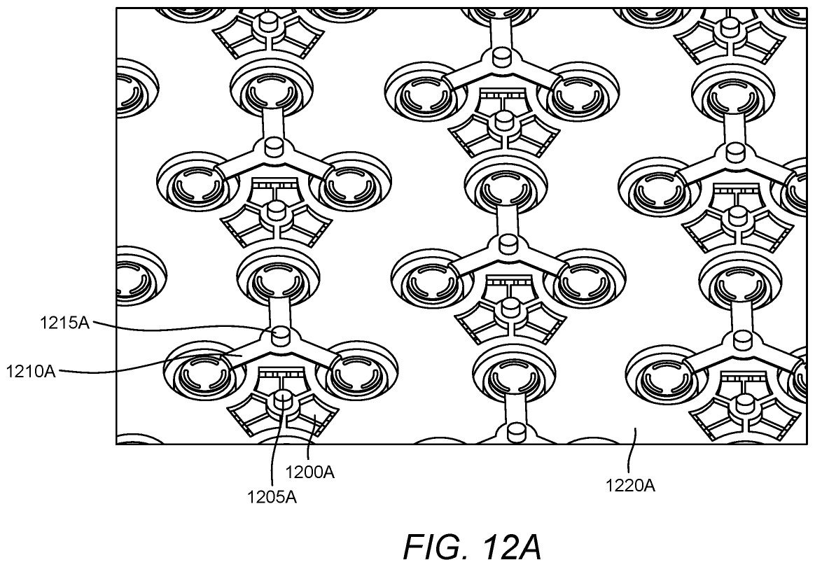

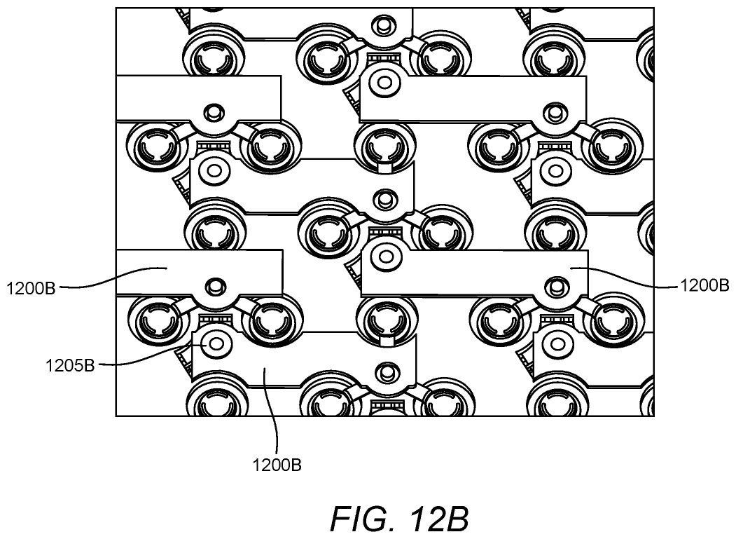

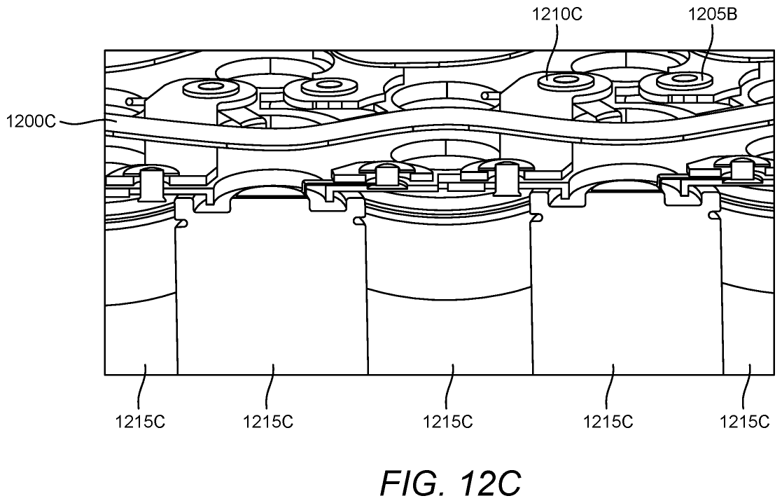

FIG. 12A illustrates a cell connection configuration for a battery module accordance with another embodiment of the disclosure. In contrast to the cell connection configuration design depicted in FIGS. 6-11B where sheet metal parts are used to facilitate welding of negative contact tabs to multiple negative cell terminals while each positive contact tab connects to a single positive cell terminal, the cell connection configuration applies the multi-cell contact tab configuration to both positive and negative poles.

Referring to FIG. 12A, a first sheet metal part 1200A is welded to a first pin 1205A for negative cell terminal connections, similar to FIGS. 8-10B. In FIG. 12A, a second sheet metal part 1210A is further welded to a second pin 1215A for positive cell terminal connections. In an example, the first and second sheet metal parts 1200A and 1210A may be integrated into an insulation plate 1220A, instead of being pre-assembled with the battery cells.

FIG. 12B illustrates busbars that are deployed in accordance with the cell connection configuration of FIG. 12A. As shown in FIG. 12B, busbars 1200B are each welded to the positive and negative pins of respective sheet metal parts to achieve P-Group interconnections similar to those depicted in FIG. 6. One advantage to the cell connection configuration depicted in FIGS. 12A-12B is that the busbars 1200B are shorter than those illustrated in FIG. 6, which reduces cost. However, the sheet metal parts 1210A include relatively long connections between the pins 1215A and the positive cell heads of the battery cells, which may result in power loss (e.g., due to steel being a worse conductor than the copper or aluminum used in the busbars 1200B). As shown in FIG. 12B, washers 1205B may be used (e.g., similar to the hole and washer design described above with respect to FIG. 10A). The washer 1205B is shown for a negative pin, but washers may be used similarly at the positive pins in some designs.

FIG. 12C illustrates a side-perspective of the cell connection configuration of FIG. 12B in accordance with an embodiment of the disclosure. Referring to FIG. 12C, conductive interconnections or ‘stripes’ 1200C (e.g., made from aluminum or copper in an example) are welded across the busbars belonging to a particular P-Group, which may help with current compensation. FIG. 12C also more clearly illustrates washers 1205C used at ‘positive’ pin connections in addition to the washers 1205B used at ‘negative’ pin connections as shown in FIG. 12B. The battery cells 1215C are also visible in the side-perspective of FIG. 12C.

In FIGS. 8-11B, electrical cell connection arrangements are described whereby an electrically conductive part includes a flat section (e.g., comprised of sheet metal) coupled to multiple negative cell terminals and includes a welding interface (e.g., an electrically conductive pin, comprised of Al or Cu), whereas each positive contact tab is welded directly to a respective positive cell terminal (e.g., cell head). FIGS. 12A-12C depict an alternative electrical cell connection arrangement whereby an electrically conductive part (e.g., comprised of a sheet metal part 1210A coupled to respective positive terminals and a pin 1215A functioning as a welding interface to a busbar) is used to reduce the number of welding connections between a busbar and positive cell terminals (e.g., a single busbar-to-terminal weld can be used, instead of three in this case). Accordingly, the negative electrical cell connection arrangements described with respect to FIGS. 8-11B and/or the positive electrical cell connection arrangements described with respect to FIGS. 12A-12C may be characterized as electrical cell connection arrangement for a battery module, including a first battery cell comprising a first terminal (e.g., positive or negative terminal), a second battery cell comprising a second terminal (e.g., positive or negative terminal), a third battery cell comprising a third terminal (e.g., positive or negative terminal), an electrically conductive part coupled to the first, second and third terminals (e.g., 820-825 of FIG. 8, or 1210A-1215A of FIG. 12A), and a busbar (e.g., 1010A-1010B, 1200B, etc.) comprising a contact tab that is welded to a welding interface of the electrically conductive part.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. An electrical cell connection arrangement for a battery module, comprising:
a first battery cell comprising a first terminal;
a second battery cell comprising a second terminal;
at least one busbar comprising a first contact tab aligned with the first terminal and a second contact tab aligned with the second terminal;
a multi-cell hold-down mechanism that comprises a first part clamped over the first contact tab and a second part clamped over the second contact tab,
wherein the first contact tab is welded to the first terminal through a first gap in the first part of the multi-cell hold-down mechanism, and
wherein the second contact tab is welded to the second terminal through a second gap in the second part of the multi-cell hold-down mechanism.

2. The electrical cell connection arrangement of claim 1,
wherein the first and second terminals are positive terminals, or
wherein the first terminal is a positive terminal and the second terminal is a negative terminal.

3. The electrical cell connection arrangement of claim 1, wherein the first contact tab is a multi-terminal contact tab that is coupled to negative terminals of the first and second battery cells.

4. The electrical cell connection arrangement of claim 1, wherein the multi-cell hold-down mechanism is formed from an electrically insulative material.

5. The electrical cell connection arrangement of claim 1,
wherein the multi-cell hold-down mechanism comprises a plurality of parts aligned with a respective plurality of positive terminals of a respective plurality of battery cells, and
wherein the multi-cell hold-down mechanism comprises a single part aligned with a respective plurality of negative terminals of the respective plurality of battery cells.

6. A method of assembling a battery module, comprising:
aligning a first contact tab of at least one busbar with a first terminal of a first battery cell;
aligning a second contact tab of the at least one busbar with a second terminal of a second battery cell;
clamping a multi-cell hold-down mechanism onto the first and second contact tabs such that the first and second contact tabs are secured to the first and second terminals;
welding, during the clamping, the first contact tab to the first terminal through a first gap in a first part of the multi-cell hold-down mechanism; and
welding, during the clamping, the second contact tab to the second terminal through a second gap in a second part of the multi-cell hold-down mechanism.

7. The method of claim 6,
wherein the first and second terminals are positive terminals, or
wherein the first terminal is a positive terminal and the second terminal is a negative terminal.

8. The method of claim 6,
wherein the first contact tab is a multi-terminal contact tab,
wherein the welding of the first contact tab welds the first contact tab to negative terminals of the first and second battery cells.

9. The method of claim 6, wherein the multi-cell hold-down mechanism is formed from an electrically insulative material.

10. The method of claim 6,
wherein the clamping aligns a plurality of parts of the multi-cell hold-down mechanism with a respective plurality of positive terminals of a respective plurality of battery cells, and
wherein the clamping aligns a single part of the multi-cell hold-down mechanism with a respective plurality of negative terminals of the respective plurality of battery cells.

11. An electrical cell connection arrangement for a battery module, comprising:
a first battery cell comprising a first positive terminal and a first cell rim arranged as a first negative terminal;
a second battery cell comprising a second positive terminal and a second cell rim arranged as a second negative terminal;
an electrically conductive part coupled to the first and second cell rims;
a busbar comprising a negative contact tab; and
a multi-cell hold-down mechanism that is clamped over the electrically conductive part,
wherein the negative contact tab is welded to a welding interface of the electrically conductive part that is exposed through a gap in the multi-cell hold-down mechanism.

12. The electrical cell connection arrangement of claim 11, further comprising:
a third battery cell comprising a third positive terminal and a third cell rim arranged as a third negative terminal,
wherein the electrically conductive part is further coupled to the third cell rim.

13. The electrical cell connection arrangement of claim 11,
wherein the electrically conductive part includes a flat section in direct contact with the first and second cell rims, and
wherein the welding interface is arranged as an electrically conductive pin.

14. The electrical cell connection arrangement of claim 13, wherein part of the multi-cell hold-down mechanism is wrapped around the electrically conductive pin.

15. The electrical cell connection arrangement of claim 13,
wherein the flat section comprises a first welding area exposed by the multi-cell hold-down mechanism that is welded to the first negative terminal, and
wherein the flat section comprises a second welding area exposed by the multi-cell hold-down mechanism that is welded to the second negative terminal.

16. The electrical cell connection arrangement of claim 13, wherein the flat section comprises sheet metal and the electrically conductive pin comprises aluminum or copper.

17. The electrical cell connection arrangement of claim 11, wherein the multi-cell hold-down mechanism is formed from an electrically insulative material.

18. The electrical cell connection arrangement of claim 11,
wherein the first positive terminal is encircled by the first cell rim, and
wherein the multi-cell hold-down mechanism comprises a first section arranged as a wall between the first positive terminal and the first cell rim.

19. The electrical cell connection arrangement of claim 18,
wherein the second positive terminal is encircled by the second cell rim, and
wherein the multi-cell hold-down mechanism comprises a second section arranged as a wall between the second positive terminal and the second cell rim.

20. The electrical cell connection arrangement of claim 11, wherein the multi-cell hold-down mechanism and the electrically conductive part are pre-assembled with the first and second battery cells before the battery module is assembled.

21. An electrical cell connection arrangement for a battery module, comprising:
a first battery cell comprising a first terminal;
a second battery cell comprising a second terminal;
a third battery cell comprising a third terminal;
an electrically conductive part coupled to the first, second and third terminals; and
a busbar comprising a contact tab that is welded to a welding interface of the electrically conductive part.

22. The electrical cell connection arrangement of claim 21, wherein the welding interface is an electrically conductive pin.

23. The electrical cell connection arrangement of claim 21,
wherein the first, second and third terminals are negative terminals, or
wherein the first, second and third terminals are positive terminals.

24. The electrical cell connection arrangement of claim 21, wherein the electrically conductive part comprises sheet metal.

25. The electrical cell connection arrangement of claim 21, wherein the electrically conductive part is pre-assembled with the first, second and third battery cells before the battery module is assembled.

26. The electrical cell connection arrangement of claim 21, wherein the electrically conductive part is pre-assembled with an insulative foil that is separate from the first, second and third battery cells before the battery module is assembled.
